(19) United States
(12) Patent Application Publication
(10) Pub. No.: US 2013/0017877 A1
(43) Pub. Date: Jan. 17, 2013

(54) SYSTEM AND METHOD FOR END-GAME PLAY OF A MACHINE-BASED CASINO TYPE GAME

(71) Applicant: FREDRIK A. DAHL, Loerenskog (NO)

(72) Inventor: FREDRIK A. DAHL, Loerenskog (NO)

(73) Assignee: BRAIN GAMES, L.C., Dallas, TX (US)

(21) Appl. No.: 13/546,737

(22) Filed: Jul. 11, 2012

Related U.S. Application Data
(60) Provisional application No. 61/508,357, filed on Jul. 15, 2011.

(51) Int. Cl. G06F 17/10

(52) U.S. Cl. 463/16

(57) ABSTRACT

A system and method for conducting end-game play between at least one live player and at least one machine-implemented player wherein the machine-implemented game generates a probability distribution and selects an action based on the probability distribution at an end stage of the game.

### CROSS-REFERENCE TO RELATED APPLICATIONS

This application claims benefit of U.S. Provisional Application No. 61/508,357, filed Jul. 15, 2011, entitled SYSTEM AND METHOD FOR END-GAME PLAY OF A MACHINE-BASED CASINO TYPE GAME (Atty. Dkt. No. BRGM-30663), the specification of which is incorporated herein in its entirety

### TECHNICAL FIELD

The present invention relates to methods and systems for conducting a machine-based game wherein the player's hands include private cards and community cards that the players may combine with their respective private cards and wherein the machine-based game employs a system and method for decision making after the final card of the hand is dealt.

### BACKGROUND

In numerous types of card games, players wager on the perceived “strength” of a hand including a combination of “pocket” or private cards, known only to the individual player, and community cards. The community cards are available to all of the players, and may be combined with an individual's pocket cards to form a hand. A number of such games are popular and widely played, in many instances in a casino-type environment. Implementing such games on electronic game machines wherein the machine-based game plays against a human, (e.g., live player) provides human players with an opportunity to wager on the outcome of such games.

Suitable games for implementation in connection with a machine-based gaming system and method as disclosed herein include various different poker and similar games. The game system operator is represented by an electronic game machine suitable for implementing and playing the game. As used herein, the term “game machine” is used to refer to electronic game machines of the type used in casinos. The terms “machine-based game” and “machine-implemented game” refer to games played on such electronic game machines. The electronic game machines may be configured to accept a wager in the form of value from a human player in exchange for playing a game of chance. As used herein, the term “wager” means value in the form of currency, credits recorded or debited on a stored value card, tokens, tickets, etc., which have a value that may be expressed in terms of currency. The value may be in the form of cash, game tokens, game tickets, a credit card or stored value card. After receiving the value, the game is played and the machine-based game resolves the outcome of the game and may dispense value in the form of a prize, i.e., a “payout” depending on the result of the game. The payout may be in the form of currency, a credit to a stored value card, a token or a ticket redeemable for currency or other value.

### SUMMARY

The present invention includes systems and methods for conducting a casino-style game. According to an embodiment of the present invention, a system is provided for conducting a game between a machine-implemented player and at least one live player. The game produces a game outcome such as, for example, a determination of which of the machine-implemented game and live player won the game. In one variation, the live player and the machine-implemented player may place one or more wagers at the final stage of the game and the game outcome is used to resolve the wagering.

The system includes a processor and a data storage unit that communicates with the processor. The data storage unit stores instructions executable by the processor, including one or more predetermined rules or strategies for responding to a given game state. In one variation, the actions taken by the processor include at a final stage wagering decision such that the game outcome includes a win or loss of wagers. The system also includes a casino-style gaming machine for enabling human players to play a selected game. The gaming machine includes a gaming machine processor, a gaming machine interface in communication with the gaming machine processor, and a gaming machine data storage device in communication with the gaming machine processor. The gaming machine data storage device stores instructions executable by the gaming machine processor to conduct the game.

The instructions typically include a game program that receives input including an action (such as a wager) from the live player through an interface with the game machine. The machine-based game evaluates the game outcome and resolves wagers made during the course of play. In the case of a poker game, in which wager(s) are accumulated in a “pot” the pot may be distributed depending upon the winner of the hand. If the human player has the superior hand, at least a portion of the pot may be distributed to the human player.

In one embodiment, an electronic game machine is configured to simulate a casino-style game with a machine-implemented game. The game machine includes a display device for displaying indicia representative of a game state, an interface for receiving an input from a live player of the casino-style game and a storage device for storing a game algorithm. The game machine further includes a processor operative with the storage device to implement the game algorithm and operative with the display device to display indicia representative of a game state. The game machine is thereby configured to play the casino-style machine-implemented game with the live player. The outcome of the game is typically based on the strength of the live player's hand vs. the machine-implemented game's hand as represented by a combination of displayed indicia visible to the live player and accessible to the machine and hidden indicia whereby the hidden indicia of the machine-implemented game is not displayed to the live player. The game machine further includes means for receiving at least one wager from the live player entitling the live player to a payout if the live player wins the casino-style game. The game machine is configured to use game-theoretic approximations, calculated with numerical methods, to identify actions corresponding to the strength of the electronic game machine game state at the end stage of the game. The game machine may then take an action based upon the estimated strength of its position.

### BRIEF DESCRIPTION OF THE DRAWINGS

FIG. 1 is front view of a electronic game machine for implementing a casino-style machine-based game according to the disclosure;

FIG. 2 is a first representative display screen illustrating a casino-style machine-based game;

FIG. 3 is a block diagram of a system for implementing a machine-based game according to the disclosure;

FIG. 4 is a second representative display screen (graphical user interface) illustrating a casino-style machine-based game;

FIG. 5 is a graphical representation of a probability distribution of a hand strength distribution for a simplified casino-style game;

FIG. 6 is a graphical representation of a probability distribution of a hand strength distribution for a more complex casino-style game; and

FIG. 7 is flow chart illustrating a method of end stage play by a machine-implemented game according to the disclosure.

### DETAILED DESCRIPTION

Reference is now made to the figures wherein like parts are referred to by like numerals throughout. The present invention is directed to a method and system for conducting a game between at least one machine-implemented player and at least one live player.

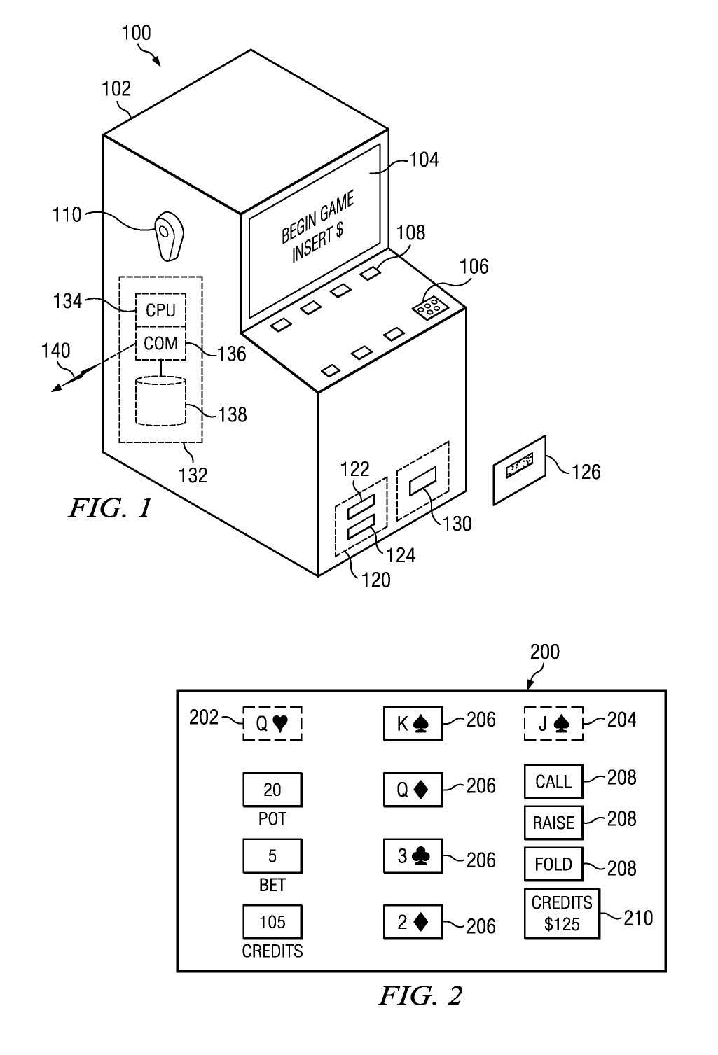

Referring to FIG. 1, there is illustrated a diagrammatic view of an electronic game machine 100 suitable for use in connection with a system and method as described herein. Electronic game machine 100 is adapted for use in connection with a casino-style game. Machine 100 includes a chassis 102 for mounting a display 104 and one or more user interfaces that enable a human user to interact with the system and play the machine-based game. In one embodiment, display 104 may comprise a user interface such as a graphical touch screen (GUI). Other user interfaces may include a keypad 106, buttons 108, levers 110, or switches that enable the user to interact with the machine-implemented or machine-based using game machine 100. User input is based on a decision to take an action. In the case of a machine-implemented poker game, the action may be to place a bet, raise, call/check or fold.

In different embodiments, electronic game machine 100 is provided with a payment input device 120 enabling a human player to wager by entering value via the payment input device. The payment input device 120 may be a currency counter/input device 122 a card reader, token reader, or similar device 124 that permits a human player to use a credit card, debit card, smart card, bar coded ticket or other stored value card or token to place a wager. In some embodiments, device 124 may comprise a bar-code reader or similar device that may be used to read a bar or similar code from a user card or a device such as cell phone or similar device capable of displaying a machine-readable code.

In one embodiment, a stored value card 126 is used to record and store a player's position, e.g., the value of the player's position in currency or wagering units. This feature allows a player to go from one machine to another in a casino or similar establishment having multiple game machines to play different casino-style games. Machine 100 may also include a cash, ticket or token dispenser 130 to provide payments or dispense tokens or tickets to a human player of the machine-based game.

Display 104 provides a human player a visual interface with the electronic game machine 100. Display 104 may show an indicia representative of a game state, for example a simulation of the cards in play.

Referring to FIG. 2, by way of example, a representative display screen 200 associated with a machine-implemented five card stud game, displays a game state after the last card of the hand is dealt. The human player's private card 202 (queen of hearts) will be displayed to the human player, but the machine-implemented game itself has no access to, or will not consider, the human's private card in connection with subsequent actions by the machine-implemented game. Thus, actions by the machine-implemented game may be determined by the private card of the machine-implemented game without consideration of the human player's private card. Similarly, the private card 204 (jack of spades) of the machine-based game will appear to the human user on display screen 200 as if the card were turned down, but electronic game machine 100 will have access to the information associated therewith.

Community cards 206, (king of spades, queen of diamonds, three of clubs and 2 of diamonds) are displayed to the human user and will be known by machine 100. During play, the human player may select various actions, i.e., raise, fold, check or call, using one or more user interface devices. In one embodiment wherein display 104 of game machine 100 comprises a touch-screen display, the human player may select various actions, such as a call, a check or a raise by means of “buttons” 208 presented on display screen 200. In one embodiment, a player's position, e.g., the value of the player's position 210 in currency or in available wagering units may be presented on display screen 200. In different embodiments, the human player may use buttons 208 or another user interface to select different actions.

Referring again to FIG. 1, game machine 100 may include a control unit 132 provided with a CPU or processor 134, a data transfer and communications interface 136 and a data storage device 138. Communications interface 136 may be operable to provide data transfer and electronic communications between control unit 132 and user interfaces such as display 104, which may be a touch screen, and other user interfaces such as a keypad 106, buttons 108, levers 110, payment input module 120 and dispenser 130.

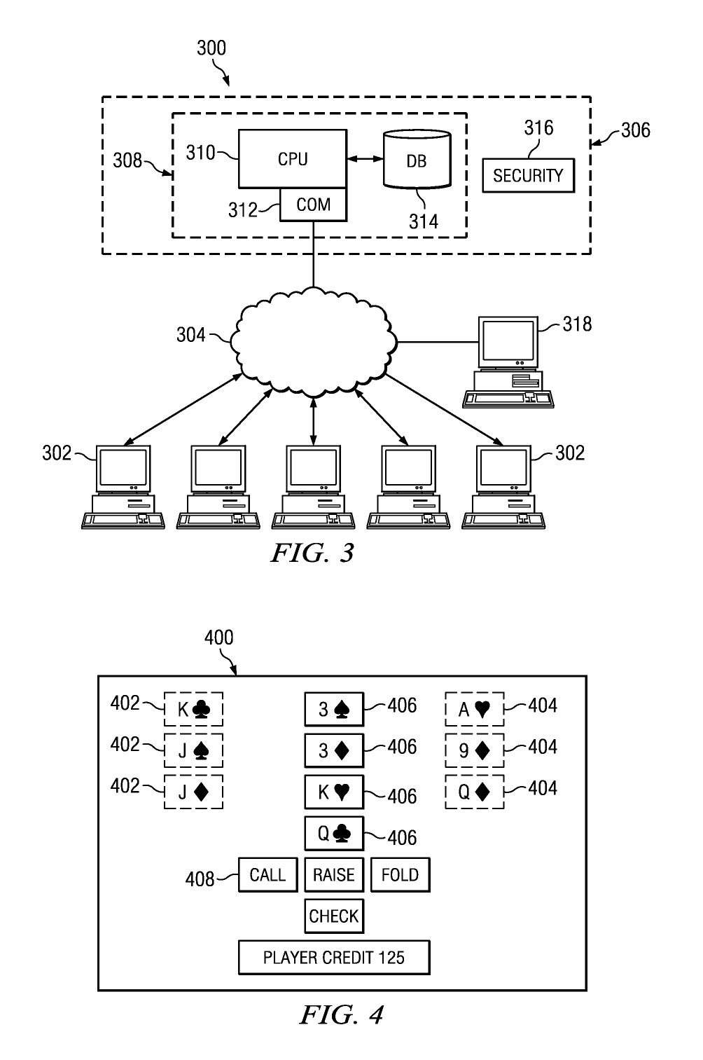

Communications interface 136 may also provide a hard-wired or wireless link 140 for data transfer and electronic communications between control unit 132 and a central office (FIG. 3) or processor 134. Game algorithms and other operating instructions may be stored on data storage unit 138. Game states, credit balances of a human player, historical data and similar information may also be stored on data storage unit 138. Different machine-implemented games may be downloaded from the central office to processor control unit 132 and/or stored on data storage unit 138, enabling electronic game machine 100 to play selected games on a stand alone basis.

FIG. 3 is a block diagram illustrating a system 300 for implementing machine-based games with a plurality of electronic game machines 302 in one or more casino(s) or similar establishment(s). It will be appreciated that in some embodiments, system 300 could be configured to implement the machine-based game or games over a private or public network 304 such as the Internet to enable individual human players at remote locations to participate.

System 300 includes one or more central offices 306, which may include one or more dedicated computer servers 308 with processors 310 and data storage devices 314. System 300 may include a number of electronic game machines 302 operatively connected to central office 306. Central office 306 may be located remote from electronic game machines 302 and may control the electronic game machines located in multiple remote locations. It will be understood that central office 306 may directly control the operation of game machines 302 during play, or alternatively, monitor the operation of the game machines.

Network 304 may be a hard-wired or wireless Local Area Network (LAN), a Wide Area Network (WAN) or the Internet. In this embodiment, game machines 302 may be located at the same or different locations. One or more data communication interfaces 312 may be utilized to facilitate communications (data transfer and electronic communications) between game machines 302 and central office 306. Data communication interfaces 312 are typically hardware devices sufficient to support communications between game machines 302, central office 306 and/or a system administrator 318. System administrator 318 may monitor the operation of game machines 302.

In one variation, game machines 302 may employ one or more Application Specific Integrated Circuits (ASICs) with specific preprogrammed instructions hard-wired or burned into non-volatile memory to implement the methods described herein. In different embodiments, game machines 302 may include a combination of preprogrammed software along with dedicated hardware and firmware to implement casino-style machine-based. One or more physical and/or electronic security measures generally indicated at 316 may be employed to maintain the central office 306 and to prevent tampering. Such measures may include locating central office 306 in a locked room or enclosure, using alarms, motion detectors, proximity sensors or similar devices and employing various software and electronic measures to prevent tampering and/or unauthorized access to the central office. Transmissions between central office 306 and electronic game machines 302 may be encrypted using known techniques such as TSL or SSL protocols to prevent hacking or unauthorized access to the central office and the game machines.

FIG. 4 is a representative touch screen interface (GUI) 400 that may be displayed by a game machine 302 at the final stage of a poker game known as seven card stud. As illustrated, four community cards 406 are displayed, e.g., a three of spades, a three of diamonds, a king of hearts and a queen of clubs. The human, (live) player has three pocket or private cards 402: a king of clubs, a jack of spades and a jack of diamonds. Alternatively, the machine-implemented game has three pocket cards 404: an ace of hearts, a nine of diamonds and a queen of diamonds. The pocket or private cards 404 of the machine-implemented game are not displayed to the human player. Similarly, the pocket cards of the human player 402 are not known, or considered, by the machine-implemented game in determining a final action. At this stage, the human player has the option of raising, checking, folding or calling a raise by the machine-implemented game utilizing buttons 408 displayed on the GUI 400. The machine-implemented game's action is determined as described below.

The following describes a method for determining play for the last betting stage (street) of a machine-implemented two-player poker game. The method utilizes a preprogrammed decision module for earlier stages of the game. The preprogrammed decision module may utilize known probability distributions based upon a game state as play progresses through the hand. Of course, the game state, e.g., the relative strength of the hands held by the machine-implemented game and the human player may change during the course of play as cards are dealt and actions are taken by the players.

The method employs a two step approach. First the probability distribution of hand strengths for both sides, e.g., the machine-implemented game and the human player are estimated, assuming all previous decisions in the deal were made according to the decision module. Such probability distributions are commonly referred to as “ranges” in poker terminology. The second step utilizes numerical methods to solve an abstract game represented by the probability distributions.

First, the reference value v of a five-card hand is defined as the probability that it is stronger than a completely random hand. The values range from v=0 to v=1. In standard poker, the hand 23457 without a flush has v=0, while a royal flush (AKQJT of the same suit) has a value v=1. The hand KKJ87 has reference value v=0.8742, because a random five-card hand has 83.8% chance of being weaker than this. In this manner, the reference value v may be defined for any 5-card hand.

In deuce-to-seven lowball games, the scale is inverted, so that 23457 non-flush is the strongest hand (hence the name), while a royal flush is the weakest. In this game, KKJ87 has value v=0.1258. In some versions of lowball poker, flushes and straights do not count such that A2345 is the strongest hand with v=1, and AAAAK is the weakest with v=0. There is also a lowball variation with 4 card hands, known as Badugi, where A234 of different suits is the strongest hand.

At the final betting stage of a given form of two-player poker, each player, e.g., the machine-implemented game and the live player, may have a set of unexposed cards, a set of exposed cards and a set of discarded cards. There may also be a set of exposed community cards. Prior to the final stage there may have been a sequence of actions (typically bets and/or discards) for both sides. For the purpose of illustration, Fx(v) may be the conditional probability that the first player has a hand with a reference value higher than v. This probability is conditional on all exposed cards and all observable actions taken by the first player earlier in the deal. In this regard, it is assumed that the previous actions were made according to the pre-programmed decision module. Similarly, Fy(v) is defined as the conditional probability that the second player has a hand value higher than v, assuming that side's decisions were also made according to the pre-programmed module. The hand strength probability distributions Fx and Fy are increasing functions with Fx(0)=Fy(0)=0 and Fx(1)=Fy(1)=1. In statistics terminology Fx and Fy are cumulative probability functions.

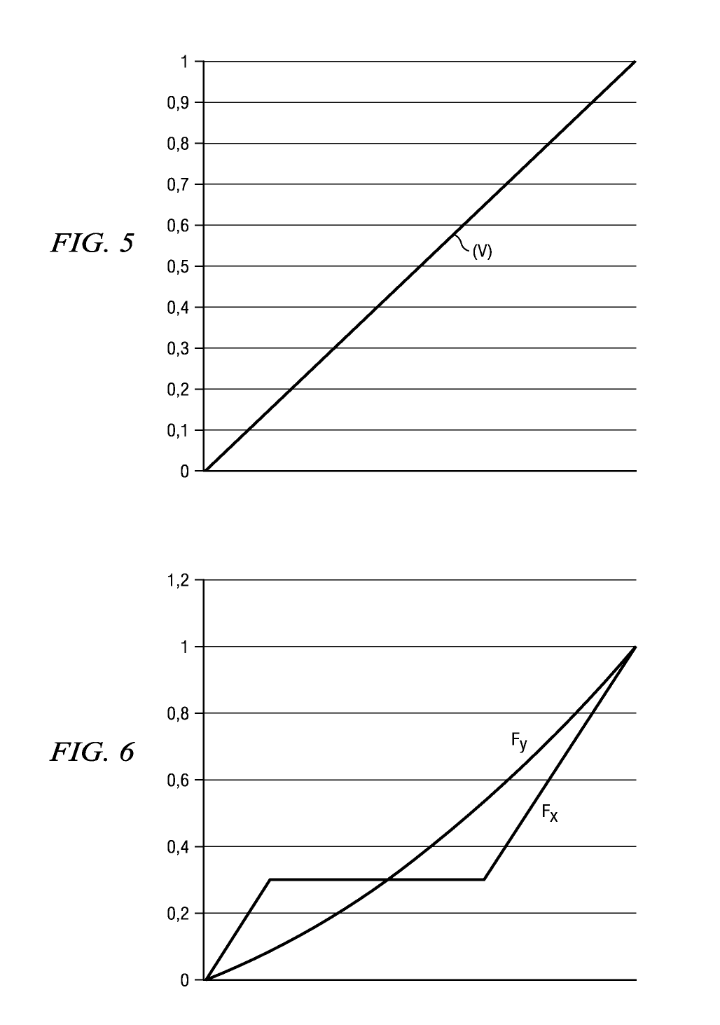

By way of example, in a simplified two-player poker game, the game goes directly to the final betting stage after five cards are dealt to each player. In this game, Fx(v)=Fy(v)=v, as illustrated in FIG. 5. A more complex example, may be illustrated in connection with a game of deuce-to-seven single draw lowball, where player X has drawn zero cards and player Y has drawn two cards. FIG. 6 illustrates potential values for Fx and Fy in such a more complex poker game.

Referring still to FIG. 6, the shape of player X's probability distribution shows a positive probability to strong and very weak hands, while zero probability to medium strength hands, e.g., the curve is flat in the middle. When player X receives a strong starting hand, he draws no cards, as this would often weaken his hand. Alternatively, if player X only stands pat with strong hands, player Y can exploit the play by calling the final stage bet only with strong hands. To prevent this, player X may stand pat with weaker hands, for example a 33355, with the intent of bluffing. As illustrated, player Y's probability distribution Fy is smoother, because he may get a wide variety of v-values after drawing two cards. The distribution is, however, shifted to the right of a diagonal line F=v, because player Y on average will receive better than completely random hand values.

Referring again to FIG. 5, a hand strength probability distribution is an increasing function with a graph starting at the lower left corner (0,0) and ending at the upper right corner (1,1). In a specific final stage situation, assume N is the number of all possible hands, and let hᵢ be hand number i. The list of hands is sorted in ascending order of strength so that hᵢ is the weakest, hₙ is the strongest, and the value for a hand hᵢ is v=i/N. Px(h) is the probability that player X would have played hand h according to the preceding actions.

The following pseudo-code computes an array p such that pᵢ is the probability that player X has a hand weaker than the value v=i/N:

Algorithm 1:

p₀ = 0
For i = 1, ..., N {

pᵢ = pᵢ₋₁ + Px(hᵢ)

}
For i = 0, ..., N {

pᵢ = pᵢ/p_{N}

}
The array p is a representation or the probability distribution Fx, and it is evaluated by: Fx(v) = p_{vN}, where the index vN is truncated to an integer value. The computation of Fy is identical, with Py(h) instead of Px(h).

The final stage of the game is approximated with an abstract game where both sides receive a single value, (v and w, respectively) and higher values represent better hands. The value v is drawn according to the first player's probability distribution Fx(.), and w is drawn according to Fy(.). The draws of v and w are independent. The betting structure and the size of the pot is the same for the actual and abstracted game. The game is an abstraction in that all information related to cards and previous betting is condensed to a single number for both sides. Under the assumption that both sides play the previous stages according to the pre-programmed decision module, it is a fair approximation of the actual final stage game, but it is not exact, because of the assumed independence between v and w.

The advantage of representing hands by their strength in the interval (0,1) is that hands with similar value may be grouped and assigned the same action. This also makes it less difficult to eliminate dominated strategies like calling with weak hands and folding better ones. Thus, a player's strategy through intervals may be associated with specific sequences of actions, for example, checking with the plan of calling if the other side bets.

A simplified example may be as follows: assume that only player X has the right to bet, and if he does, player Y can either fold or call. Player Y's non-dominated strategies can be represented by a number y0, interpreted as his calling threshold: player Y calls a bet from player X whenever he has a hand stronger than y0, and folds otherwise. Player X's non-dominant strategies are specified by two thresholds; x0 and x1, such that he bets when his hand value is below x0 (bluffs) or above x1 (value bets). For hands between these thresholds, X will not bet, because the hands with which Y calls are on average stronger (so that X loses), while the hands Y folds are mostly weaker (so a bet by X makes no difference).

In this case, solving the game requires determining or estimating the three thresholds y0, x0 and x1. In the special case where all hand values v are equally likely; e.g., Fx(v)=Fy(v)=v for all v and the bet size is half the pot, the solution is x0=0.1, x1=0.7 and y0=0.4. This gives a so-called Nash equilibrium, because neither player X nor player Y can improve their average outcome by deviating unilaterally. Assume that the actual game is a simplified poker game as described above, and that the machine-implemented game, in this case, player X, is dealt KKJ87. Given that this hand has v=0.8742, which is larger than x1=0.7, player X will place a wager on the hand.

When the game rules allow bets and raises from both sides, the unit interval is partitioned into a larger number of intervals. For example, if the rules allow a bet and three raises, possibly starting with a check, X's strategy consists of 13 consecutive intervals with sequences of actions bet-fold, check-fold, check-raise-fold, check-call, bet-fold, bet-re-raise-fold, bet-call, check-raise-fold, check-raise-re-raise, check-raise-call, bet-re-raise-fold, bet-re-raise-call, check-raise-re-raise. With his weakest hands, player X will bet (bluff) with the intention of folding to a raise, while with his strongest hands he will check and raise back twice if given an opportunity. Player X's strategy is given by the 12 threshold points between his 13 strategy intervals. Similarly, player Y's strategy is given by 12 thresholds.

Small adjustments are made to the locations of the threshold points between the action intervals, so that the average result (expected value) is increased. The procedure converges to a solution where the strategies are in equilibrium, which means that neither side (player X and player Y) can improve their average outcome by changing strategy. For illustration, let x0, . . . , xn and y0, . . . , ym be X and Y's thresholds, respectively. Let Oxi(x,y) be X's expected gain (possibly negative) from shifting his threshold xi a small step upwards. Also let Oyj(x,y) be Y's expected gain from shifting his threshold yj a small step upwards. Then:

Algorithm 2:

repeat M times {

For i=0,...,n

xi = xi + Oxi(x,y)

For j=0,...,m

yj= yj + Oy(x,y)

}

Different variations of poker have different sequences of actions and different numbers of private cards, which means that the computation of the hand strength probability distributions Fx(.) and Fy(.) will to some extent be game-dependent. In the case of limit “holdem,” on the river card, there are five exposed community cards. The possible number of two-card pocket hands for either player is therefore (47*48)/2=1081. Only hand values that can be realized need to be taken into account, so in Algorithm 1 the iteration considers the N=1081 possible hands. The decision module is used to compute Px(h) and Py(h); the probabilities that the program would have made the actual decisions that lead to the river stage with a given hand h, playing X and Y, respectively. When the resulting abstract game associated with Fx and Fy has been solved, the program inspects its hand, evaluates its value v, identifies an action interval that contains this v, and makes the action associated with the interval.

In the case of five card stud, each player has only a single hidden card, and there are 8 exposed cards. Therefore, there are only 52−8=44 different hands for each side, making N=48 in Algorithm 1. In the game of seven card stud, each player has a total of 3 hidden cards, which means that a computer analysis is considerably slower, because the analysis must evaluate the likelihood of all possible three-card pocket combinations for both players. In this case a Makov chain Monte Carlo (MCMC) simulation may be used to estimate Fx(.) and Fy(.). This method amounts to randomly drawing a sequence of 3-card combinations, and accepting those with a high likelihood as representative of probable hands. In the case of draw poker, the set of hidden cards seen by a player (five+the number of discards) is so large that the MCMC simulation approach used for seven card stud may be used. Similarly, in triple draw lowball, single-draw lowball and Badugi, MCMC simulations may be required to estimate Fx(.) and Fy(.) in a practical time frame.

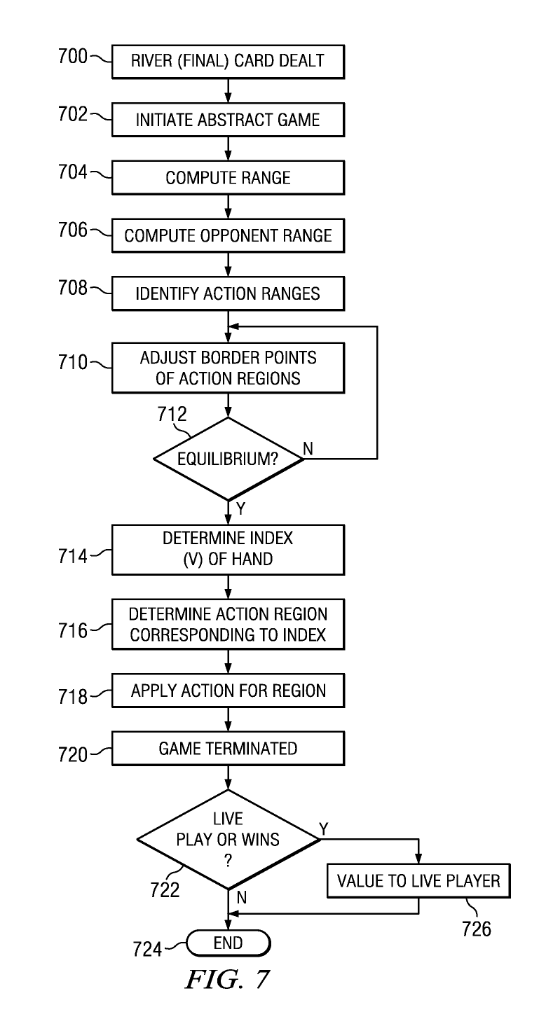

FIG. 7 is a flow chart illustrating a system and method for conducting a machine-implemented casino-style game including pocket and community cards as described above. In one embodiment, the machine-implemented game plays the game until the final stage, (last sequence of actions) using a preprogrammed decision module. The decision module may control the actions of the machine-implemented-game based on probability distributions based on a preprogrammed analysis of the cards available (game state) at different stages of play. For example, in a game of five card stud, if the machine-implemented game initially receives a high value pocket card, the machine-implemented game may be programmed to adopt an aggressive strategy, raising and calling wagers made by a human player. Alternatively, if the machine-implemented game has a weak pocket card, the game machine may fold, terminating play of the hand. In different embodiments, a random component may be introduced into the actions and responses of the machine-implemented game to avoid predictable responses to a given game state. For example, the machine-implemented game may, on a random basis, adopt an aggressive strategy with a weak hand as a means of simulating “bluffing.”

At the final stage of the game, the decision module approach is replaced with a solution to a game-theoretic approximation, computed with numerical methods. The system and method may be utilized in various poker games wherein a first method may be used to determine actions by the machine-based game in some stages or game states and a second method may be employed to determine actions taken by the machine-implemented game at the end stage of the game.

Referring still to FIG. 7, the process begins at step 700 when the final card of the hand is dealt. In this embodiment, when the final card has been dealt, the decision module approach utilized by the machine-implemented game is replaced with a game-theoretic approximation, calculated with numerical methods. The machine-implemented game then initiates the abstract game described above at 702, determines its range 704 and the live player's range at 706. To this end, the machine-implemented game first computes the likelihood that it would have taken all the actions made in the game based on the decision module. This is a known Bayesian computation, which produces the conditional probability of each hand, given the actions taken.

The machine-implemented game then applies the same computation to the opponent at step 706. The strength of the potential hands are computed and sorted accordingly, from weakest to strongest at step 708. This procedure provides a parameterized range for both sides on a unit interval [0,1], where 0 refers to the weakest hands and 1 corresponds to the strongest possible hand. Thus, if v is 0.7, Fx(v) is the sum of the probability of the 70% weakest hands and Fy(v) denotes the probability that the opposing (live) player has a hand better than the fraction v of possible hands. As previously described, the machine-implemented game solves the abstract game by adjusting the border points between the regions so that several equilibrium conditions are satisfied e.g., the length of an action region is scaled such that a player is indifferent between possible actions. As described above, an iterative algorithm is used at step 710 to make small adjustments to the locations of the border points between action regions, so that the average result (expected value) is increased. The iterative procedure continues until it converges to a solution at step 712 where the strategies are in equilibrium, which means that neither side can improve its average outcome by changing its strategy.

When the abstract game has been solved, the program applies it to the current hand. First, the machine-implemented game identifies the index of its hand in the list of possible hands at step 714. The machine-implemented game then identifies an action region that contains the index (v) at step 716, and applies the action associated with this region at 718. At step 720, after the machine-implemented game has applied the action, whether the human player has won the hand is determined at 722. If the human player loses, the game ends at 724. Alternatively, if the human player wins, the pot (or a portion thereof) is awarded to the human player at 726.

It will be appreciated by those skilled in the art having the benefit of this disclosure that the system and method disclosed herein for end game play of a machine-implemented casino-style game provides a means of implementing a variety of such games on electronic game machines. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for conducting a casino-style game between at least one machine-implemented player and at least one live player, the game producing a game outcome, comprising:
receiving an input including a wager from the live player and producing a game outcome by controlling said machine-implemented player against the live player;
utilizing game-theoretic approximations, calculated with numerical methods, to identify actions corresponding to the strength of the machine-implemented player's position, at an end stage of the game;
taking an action based upon the estimated strength of the machine-implemented game position; and
evaluating the game outcome and resolving the wager.

2. The method of claim 1, wherein the machine-implemented game estimates a probability distribution for the possible strength of the machine-implemented player position and the live player position at the end stage of the game.

3. The method of claim 2, wherein the machine-implemented game utilizes the estimated strength of the machine-implemented player position to select an action at the end stage of the game.

4. The method of claim 1, further comprising providing a display of selected indicia indicating a status of the live player's position in the game.

5. The method of claim 4, further comprising providing a display of selected indicia indicating a status of the machine-implemented game's position in the game.

6. The method of claim 5, wherein the indicia comprise representations of playing cards displayed by the machine-implemented game on a display associated with the machine-implemented game.

7. A system for simulating a machine-implemented casino-style game utilizing at least one electronic game machine, the system including:
at least one electronic game machine, the electronic game machine including a display device for displaying indicia representative of a game state, an interface for receiving an input from a live player of the game and a storage device for storing a game algorithm, wherein the game machine further comprises a processor operative with the storage device to implement the game algorithm and operative with the display device to display indicia representative of a game state whereby the game machine is configured to play a casino-style machine-implemented game with the live player;
wherein the outcome of the casino-style game is based upon a combination of displayed indicia visible to the live player and accessible to the machine and hidden indicia whereby the hidden indicia of the machine-implemented game is not displayed to the live player;
wherein the electronic game machine is further configured to receive at least one wager from the live player entitling the live player to a payout if the player wins the casino-style game;
wherein the electronic game machine is configured to use game-theoretic approximations, calculated with numerical methods, to identify actions corresponding to the strength of the electronic game machine game state such that the electronic game machine takes an action based upon the estimated strength of its position; and
a central processor connected to the electronic game machine, the central processor operative to receive an input from the electronic game machine corresponding to the outcome of games played on the electronic game machine.

8. The system of claim 7, further comprising a data interface between the electronic game machine and the central processor whereby the outcome of games played by live players are transmitted to the central processor.

9. The system of claim 7, wherein the machine-implemented game is poker.

10. The system of claim 7, wherein the displayed indicia are visual representations of playing cards.

11. The system of claim 7, wherein the machine-implemented game estimates a probability distribution for the possible strength of the machine-implemented player position and the live player position at the end stage of the game.

12. The system of claim 11, wherein the machine-implemented game utilizes the estimated strength of the machine-implemented player position to select an action at the end stage of the game.

13. The system of claim 7, wherein the electronic game machine further comprises means for receiving value from a live player.

14. The system of claim 7, wherein the electronic game machine further comprises a stored value card reader whereby value may be transferred from and to the stored value card by the electronic game machine.

15. An electronic game machine configured to simulate a casino-style game with a machine-implemented game, the game machine including:
a display device for displaying indicia representative of a game state, an interface for receiving an input from a live player of the casino-style game and a storage device for storing a game algorithm;
a processor operative with the storage device to implement the game algorithm and operative with the display device to display indicia representative of a game state whereby the game machine is configured to play the casino-style machine-implemented game with the live player and wherein the outcome of the casino-style game is based upon a combination of displayed indicia visible to the live player and accessible to the machine and hidden indicia whereby the hidden indicia of the machine-implemented game is not displayed to the live player;
means for receiving at least one wager from the live player entitling the live player to a payout if the live player wins the casino-style game; and
wherein the electronic game machine is configured to use game-theoretic approximations, calculated with numerical methods, to identify actions corresponding to the strength of the electronic game machine game state at the end stage of the game such that the electronic game machine takes an action based upon the estimated strength of its position.

16. The electronic game machine of claim 15 further comprising a data transmission interface whereby the game machine is operative to transmit data to a central processor.
